(19) United States
(12) Patent Application Publication
(10) Pub. No.: US 2011/0141179 A1
(43) Pub. Date: Jun. 16, 2011

(54) INK JET PRINTING APPARATUS AND INK JET PRINTING METHOD

(75) Inventor: Katsushi Hara, Yokohama-shi (JP)

(73) Assignee: CANON KABUSHIKI KAISHA, Tokyo (JP)

(21) Appl. No.: 12/956,196

(22) Filed: Nov. 30, 2010

(30) Foreign Application Priority Data
Dec. 15, 2009 (JP) 2009-284026

(51) Int. Cl. B41J 2/205

(52) U.S. Cl. 347/15

(57) ABSTRACT

This invention has a plurality of print heads, each including a first and second nozzle arrays. The different print heads are arranged so as to include an overlap area. The difference in distribution rate between the plurality of nozzle arrays for the same color is set to be larger when the number of ejections in the overlap portion is equal to or larger than the threshold than when the number of ejections in the overlap portion is smaller than the threshold. The print data for the same color is distributed among the plurality of nozzle arrays for the same color so that the number of pixels with the same ink overlap sequence as that in the non-overlap areas is larger than the number of pixels with an overlap sequence different from that in the non-overlap areas when the number of ejections is equal to or larger than the predetermined threshold.

### BACKGROUND OF THE INVENTION

1. Field of the Invention

The present invention relates to an ink jet printing apparatus configured to carry out printing by providing relative scanning between a print medium and a print head including a plurality of nozzle arrays through which ink in different colors is ejected, while allowing ink to be ejected through the print head.

2. Description of the Related Art

For ink jet printing apparatuses, various configurations have been proposed which are intended to increase the speed of printing and to miniaturize the apparatus. For example, unit effectively adapted to print large-sized sheets such as A2- and A0-sized sheets at a high speed is an increase in the number of rasters that can be printed during a single main scan, that is, an increase in the length of a print head. A method for increasing the length of the print head is an increase in the number of nozzles arranged in the print head and through which ink is ejected. However, the manufacture of a single long print head with a large number of nozzles arranged therein has many difficulties and leads to an increase in costs. Thus, a method of achieving an increase in the length of a print head by arranging a plurality of conventional small print heads has been proposed. This method is very effective in terms of costs and the reliability of the print head.

On the other hand, effective unit for miniaturizing the ink jet printing apparatus is to provide a single print head internally with a plurality of nozzle arrays arranged parallel to one another and which can eject ink in the respective colors. Thus, the main body width of a color ink jet printing apparatus with a multicolor ink configuration can be reduced.

Thus, in order to increase the speed of printing and to miniaturize the apparatus, the ink jet printing apparatus used to print large-sized sheets effectively uses what is called a junction head with a plurality of print heads arranged therein so as to increase the length of the whole print head; in the junction head, a plurality of head chips capable of ejecting ink in the respective colors are arranged. However, in the ink jet printing apparatus using the junction head, differences in characteristics among the print heads or the like may cause striped density unevenness (stripes) at the junction between the print heads. This may degrade print quality.

To prevent the print quality at the junctions in the junction head from being degraded, Japanese Patent Laid-Open No. 2001-001510 proposes a configuration in which the print heads arranged in the junction head partly overlap one another in the main scanning direction of the junction head. In an ink jet printing apparatus described in Japanese Patent Laid-Open No. 2001-001510, a junction head is provided for each color used. In each junction head, rasters are formed by the overlap potions between the print heads by mixing ink dots ejected from the different print heads. Thus, even if ink ejection characteristics vary slightly between the adjacent print heads, possible striped density unevenness at the junction between the print heads can be made unnoticeable.

However, in the printing apparatus disclosed in Japanese Patent Laid-Open No. 2001-001510, junction heads are provided for the respective ink colors and arranged in a predetermined sequence in the main scanning direction. This increases the size of a space in which the junction heads are arranged, disadvantageously increasing the size of, for example, a carriage with the junction heads mounted thereon. Thus, a configuration has also been proposed in which in each of the plurality of print heads forming the junction head, nozzle arrays through which different types of ink are ejected are juxtaposed along the main scanning direction. In this case, the nozzle arrays for the plurality of colors are arranged in the same print head to enable a reduction in the number of junction heads to be arranged along the main scanning direction. This in turn enables a reduction in the arrangement space for the junction heads in the main scanning direction.

However, if each of the print heads forming the junction head includes plural type of ink, a variation in the sequence in which the ink lands on the print medium may cause print quality to be degraded depending on a printed image or a dot arrangement method.

For example, if each of the print heads forming the junction head includes nozzle arrays through which yellow ink is ejected and which are juxtaposed with nozzle arrays through which magenta ink is ejected, the arrangement of the nozzle arrays in the main scanning direction varies between a portion of each print head in which the print head overlaps another print head and the other portions. That is, in the overlap portion of the print head, the nozzle arrays are arranged in the sequence yellow, magenta, yellow, and magenta. In contrast, in the non-overlapping portion, the nozzle arrays are arranged in the sequence yellow and magenta. Thus, if the yellow ink and the magenta ink are overlapped on top of each other at the same position on the print medium so as to form a secondary color, the sequence of landing of ink droplets in the two colors ejected from the overlap portion may differ from that of ink droplets in the two colors ejected from a portion other than the overlap portion. In this case, there is a difference in hue (color unevenness) between an image printed by the overlap portion and an image printed by the other portion. This may disadvantageously cause the print quality to be degraded.

### SUMMARY OF THE INVENTION

An object of the present invention is to provide a printing apparatus using a junction head including print heads arranged therein and each having nozzle arrays from which different colors are ejected, the printing apparatus being configured to suppress degradation of print quality resulting from color unevenness caused by a variation in the sequence of ink impact and striped unevenness caused by differences in characteristics among print heads.

To accomplish this object, the present invention has one of the following configurations.

That is, a first aspect of the present invention provides an ink jet printing apparatus comprising: printing unit comprising a plurality of print heads each with a first nozzle array through which ink in a first color is ejected and a second nozzle array through which ink in a second color is ejected, the first and second nozzle array being juxtaposed along a predetermined direction, the different print heads being arranged so as to include an overlap area in the predetermined direction; distribution unit configured to distribute print data corresponding to the first color in the overlap area between the first nozzle arrays in respective two print heads of the plurality of print heads which correspond to the overlap area, and distributing print data corresponding to the second color in the overlap area between the second nozzle arrays in the respective two print heads; and counting unit configured to count the number of ejections of the ink in the first color into the overlap area and the number of ejections of the ink in the second color into the overlap area based on the print data corresponding to the first color in the overlap area and the print data corresponding to the second color, wherein: (A) the distribution unit carries out the distribution in such a manner that a difference, between the first nozzle arrays in the respective two print heads, in a rate at which the print data corresponding to the first data is distributed to the corresponding nozzle array and a difference, between the second nozzle arrays in the respective two print heads, in a rate at which the print data corresponding to the second data is distributed to the corresponding nozzle array are larger when the number of ejections counted by the counting unit is equal to or larger than a threshold than when the number of ejections counted by the counting unit is smaller than the threshold, and (B) the distribution unit distributes the print data corresponding to the first color and the print data corresponding to the second data between the first nozzle arrays in the respective two print heads and between the second nozzle arrays in the two print heads in such a manner that the number of pixels printed in the same printing sequence as that of the first ink and the second ink in a non-overlap area different from the overlap area is larger than the number of pixels printed in a printing sequence different from that of the first ink and the second ink in the non-overlap area.

A second aspect of the present invention provides an ink jet printing apparatus comprising: printing unit comprising a plurality of print heads each with a plurality of nozzle arrays juxtaposed along a predetermined direction and through which ink indifferent colors is ejected, the different print heads being arranged so as to include an overlap area in the predetermined direction; distribution unit configured to distribute print data corresponding to each of the plurality of colors in the overlap area between the plurality of nozzle arrays in the two print heads corresponding to the overlap area; and counting unit configured to count the number of ejections of the ink in the plurality of colors into the overlap area based on the print data on the plurality of colors in the overlap area, wherein: (A) the distribution unit carries out the distribution so as to set a difference in a rate at which the print data corresponding to each of the plurality of colors is distributed between the plurality of nozzle arrays in the respective two print heads, to be higher when the number of ejections counted by the counting unit is equal to or larger than a threshold than when the number of ejections counted by the counting unit is smaller than the threshold, and (B) the distribution unit distributes the print data corresponding to the plurality of colors between the plurality of nozzle arrays in such a manner that the number of pixels printed in the same printing sequence as that of the ink in the plurality of colors in a non-overlap area different from the overlap area is larger than the number of pixels printed in a printing sequence different from that of the ink in the plurality of colors in the non-overlap area.

A third aspect of the present invention provides an ink jet printing method comprising the steps of: carrying out printing using printing unit comprising a plurality of print heads each with a first nozzle array through which ink in a first color is ejected and a second nozzle array through which ink in a second color is ejected, the first and second nozzle array being juxtaposed along a predetermined direction, the different print heads being arranged so as to include an overlap area in the predetermined direction; distributing print data corresponding to the first color in the overlap area between the first nozzle arrays in respective two print heads of the plurality of print heads which correspond to the overlap area, and distributing print data corresponding to the second color in the overlap area between the second nozzle arrays in the respective two print heads; and counting the number of ejections of the ink in the first color into the overlap area and the number of ejections of the ink in the second color into the overlap area based on the print data corresponding to the first color in the overlap area and the print data corresponding to the second color, wherein in the distribution, (A) the distribution is carried out in such a manner that a difference, between the first nozzle arrays in the respective two print heads, in a rate at which the print data corresponding to the first data is distributed to the corresponding nozzle array and a difference, between the second nozzle arrays in the respective two print heads, in a rate at which the print data corresponding to the second data is distributed to the corresponding nozzle array are larger when the number of ejections counted by the counting unit is equal to or larger than a threshold than when the number of ejections counted by the counting unit is smaller than the threshold, and (B) the print data corresponding to the first color and the print data corresponding to the second data are distributed between the first nozzle arrays in the respective two print heads and between the second nozzle arrays in the two print heads in such a manner that the number of pixels printed in the same printing sequence as that of the first ink and the second ink in a non-overlap area different from the overlap area is larger than the number of pixels printed in a printing sequence different from that of the first ink and the second ink in the non-overlap area.

The present invention enables suppression of possible color unevenness in the overlap area between the plurality of print heads forming the junction head. Thus, high-quality images can be formed.

Further features of the present invention will become apparent from the following description of exemplary embodiments (with reference to the attached drawings).

### BRIEF DESCRIPTION OF THE DRAWINGS

FIG. 1 is a plan view schematically showing an ink jet printing apparatus according to an embodiment of the present invention;

FIG. 2 is a schematic diagram showing the configuration of a junction head used for the embodiment of the present invention;

FIG. 3 is a schematic diagram showing arrangement of ejection ports in print heads in a junction head;

FIG. 4 is a schematic diagram illustrating an overlap area on the junction head;

FIG. 5 is a block diagram schematically showing a control system according to the embodiment of the present invention;

FIG. 6 is a schematic diagram illustrating 2-pass printing;

FIG. 7 is a schematic diagram showing a multi-pass mask for 2-pass printing;

FIG. 8 is a block diagram schematically showing the configuration of a print control section configured to control a multi-pass printing operation using the junction head;

FIG. 9 is a flowchart showing the flow of processing executed by the multi-pass print control section;

FIGS. 10A to 10C are schematic diagrams showing the sequence of ejection of ink droplets from the junction head;

FIGS. 11A and 11B are schematic diagrams showing the sequence in which ink is fixed to a print medium if a large number of dots are provided per unit area;

FIGS. 12A and 12B are schematic diagrams showing the sequence in which ink is fixed to the print medium if a small number of dots are provided per unit area;

FIG. 13 is a diagram showing the relationship between the number of ink ejections in the overlap area and an overlap area mask suitable for that number of ejections according to a first embodiment;

FIGS. 14A and 14B are diagrams showing overlap area masks according to a first embodiment;

FIG. 15 is a diagram, showing the relationship between the number of ink ejections in the overlap area and an overlap area mask suitable for that number of ejections according to a second embodiment;

FIG. 16 is a schematic diagram showing the configuration of a junction head used for the third embodiment; and

FIGS. 17A and 17B are diagram showing the relationship between the number of ink ejections in the overlap area and an overlap area mask suitable for that number of ejections according to a third embodiment.

### DESCRIPTION OF THE EMBODIMENTS

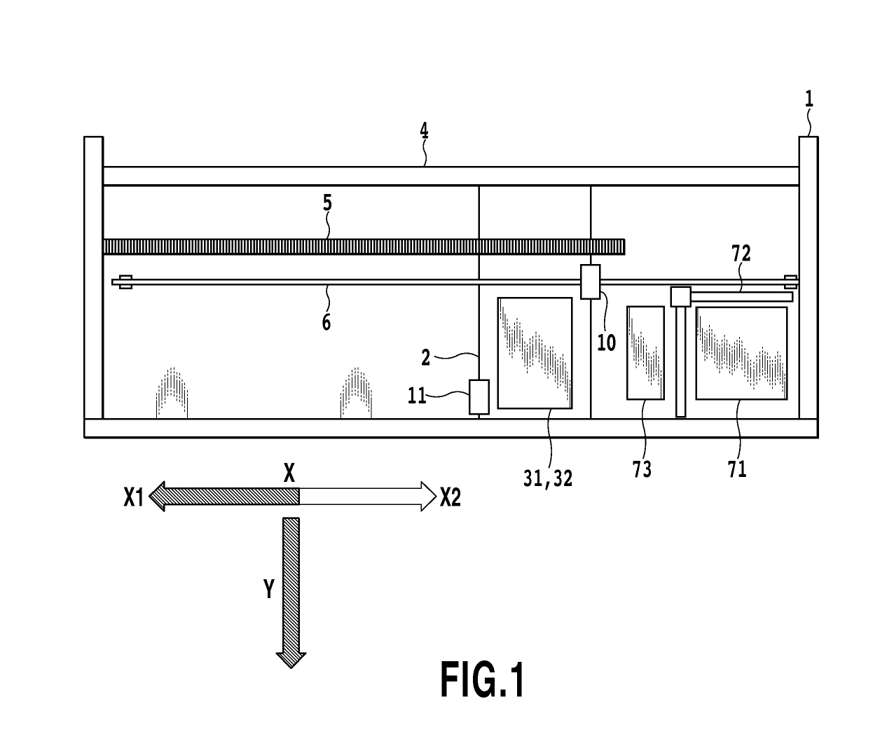

Embodiments of the present invention will be described below in detail with reference to the drawings. FIG. 1 is a plan view showing an ink jet printing apparatus according to an embodiment of the present invention. The ink jet printing apparatus includes a printing apparatus main body 1 with various mechanism sections including a unit (not shown in the drawings) configured to convey print sheets (print media), and a control system mounted in the printing apparatus main body 1 as described below. The ink jet printing apparatus according to the present embodiment is of a serial type in which a printing operation is performed by intermittently conveying a print medium in a Y direction (sub-scanning direction) while moving junction heads 31 and 32 in an X direction (main scanning direction) crossing the sub-scanning direction at right angles. The junction heads 31 and 32 are mounted on a carriage 2 supported so as to be movable along a guide shaft 4 located along the X direction. The carriage 2 is fixed to an endless belt 5 that is moved substantially parallel to the guide shaft 4 by a driving force of a carriage motor (CR motor). The carriage 2 moves forward (X1 direction) and backward (X2 direction) in the X direction (main scanning direction) together with the endless belt 5. Furthermore, the present embodiment includes a carriage elevating and lowering mechanism 10 configured to elevate and lower the carriage 2 and a print medium sensor 11 configured to sense a print medium.

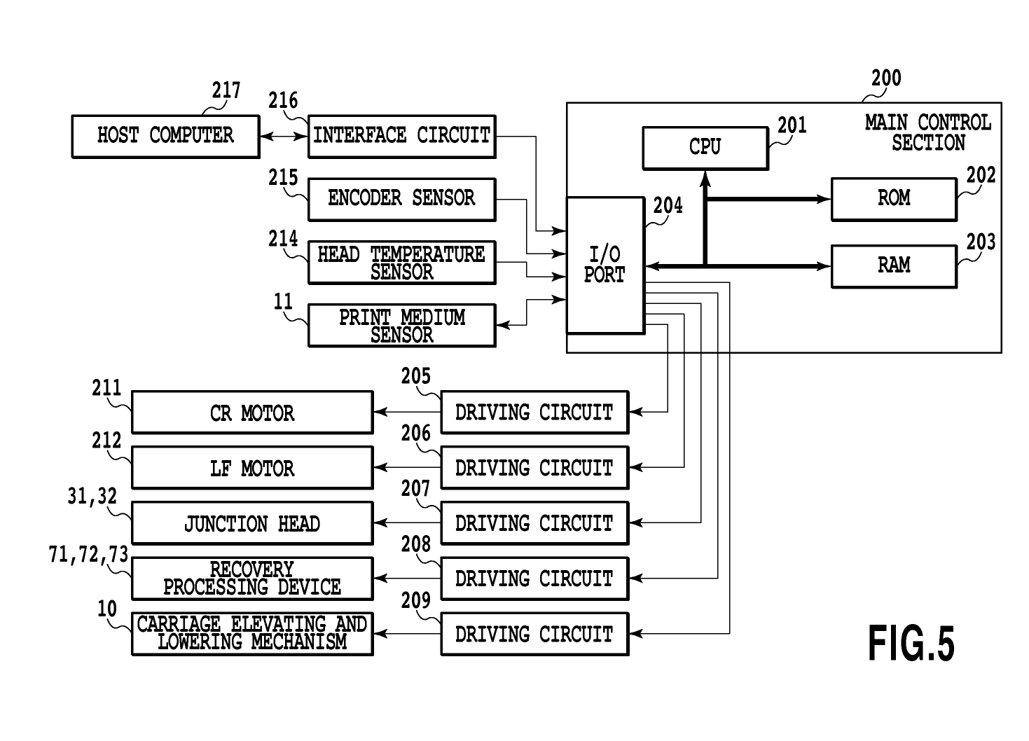

Furthermore, the position of the carriage 2 is detected by a main control section 200 by counting a pulse signal output by an encoder sensor 215 (see FIG. 5) in conjunction with movement of the carriage 2. That is, the encoder sensor 215 detects detected sections formed on an encoder film 6 located along the main scanning direction to output a pulse signal to the main control section 200 (see FIG. 5). The main control section 200 counts the pulse signal to detect the position of the carriage 2. The carriage is moved to a home position and other positions based on signals from the encoder sensor 215. A recovery mechanism is provided at the home position of the carriage 2 and in the vicinity thereof to maintain the ink ejection capability of the junction heads 31 and 32. The recovery mechanism includes a suction recovery mechanism 71 configured to refresh ink in the junction heads 31 to 34 so that the ink can be suitably ejected, a wiping recovery mechanism 72 configured to clean ejection port formation surfaces of the junction heads 31 and 32, and a reception box 73 configured to receive preliminarily ejected ink.

A printing apparatus main body 1 including the above-described components has a larger size in the X direction so as to allow relatively large sized print media (for example, AO-sized print media) to be printed.

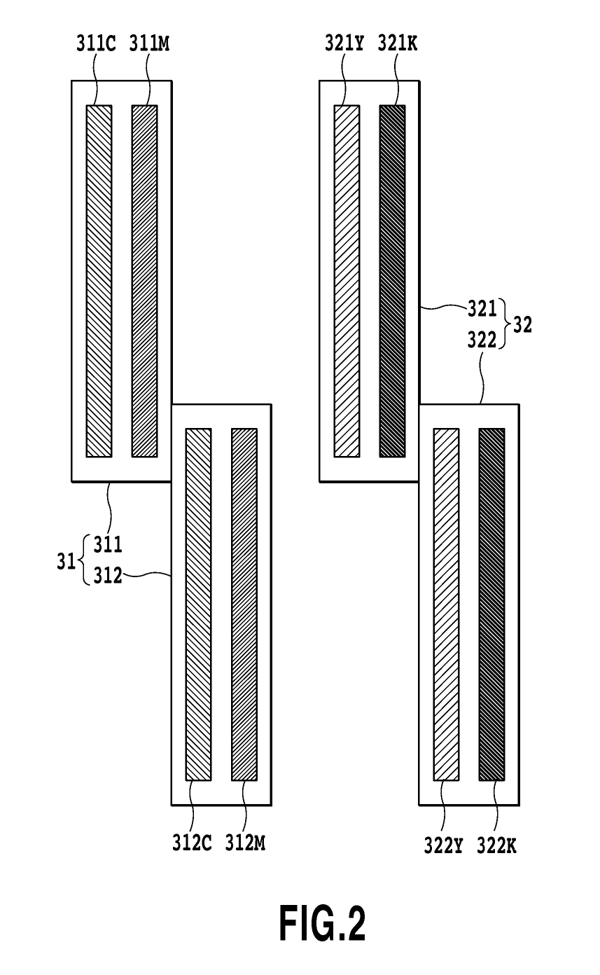

Now, the configuration of the junction heads 31 and 31 used in the ink jet printing apparatus according to the present embodiment will be described with reference to the schematic diagram shown in FIG. 2.

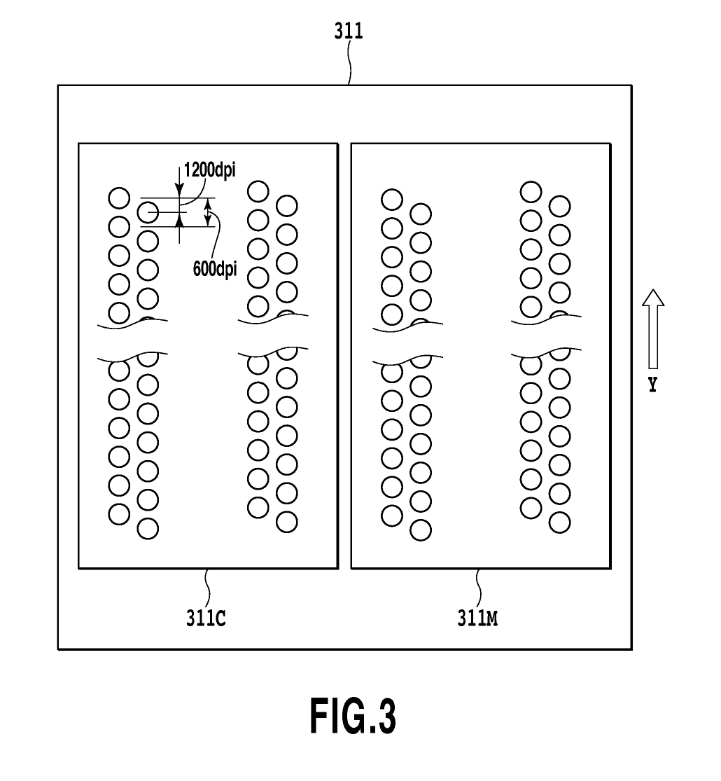

The junction head 31 includes two print heads 311 and 312. The print head 311 includes a head chip 311C serving as a nozzle array with a plurality of nozzles arranged therein and through which ink is ejected and a head chip 311M serving as a nozzle array with a plurality of nozzles arranged therein and through which ink is ejected. As shown in FIG. 3, each of the head chips 311C and 311M includes 1,280 nozzles provided at a density of 1,200 dpi (dots/inch) in the Y direction (sub-scanning direction). The ejection ports of the nozzles provided in each of the head chips 311C and 311M are arranged in a staggered manner. The term “nozzle” as used herein unit a channel through which ink fed into the print head is ejected. An opening formed at the end of each channel corresponds to the ejection port.

As described above, each of the head chips includes two nozzle arrays with the ejection ports arranged in a staggered manner as described above. Thus, a total of 2,560 ejection ports are arranged in one head chip. Moreover, an energy generation element is located in each of the nozzles in the print head 311 to generate ejection energy used to eject ink through the ejection port. In the present embodiment, as the energy generation element, an electro-thermal converter is used which locally heats ink to cause film boiling so that the resultant change in the pressure in the nozzle allows the ink to be ejected through the ejection port. However, the present invention is not limited to this aspect. Electromechanical conversion elements such as piezoelectric elements may also be used. The print head 311 has been described. The print head 312 also includes a cyan chip 312C and a magenta chip 312M. The chips 312C and 312M have configurations similar to those of the chips 311C and 311M.

The junction head 32 includes print heads 321 and 322. The print head 321 includes a head chip (hereinafter referred to as a yellow chip) 321Y configured to eject yellow ink and a head chip (hereinafter referred to as a black chip) 321K configured to eject black ink. Furthermore, the print head 322 similarly includes a yellow chip 322y and a black chip 322K.

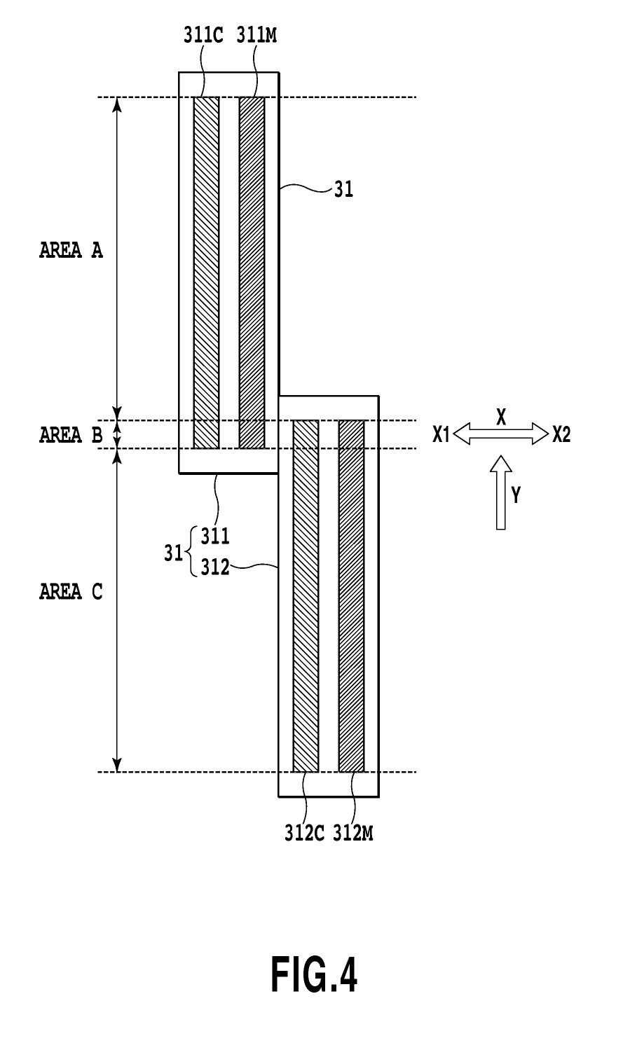

FIG. 4 is a schematic diagram showing areas specified for the junction head according to the present embodiment. The arrangement relationship among the head chips 311C, 311M, 312C, and 312M included in the junction head 31 will be described in connection with three areas A, B, and C. The area A is a non-overlap area in which only the head chips 311C and 311M are arranged in the main scanning direction (X direction). The area A corresponds to 2,464 ejection ports (in parts of the two nozzle arrays each of which includes 1,232 ejection ports arranged therein) formed in each of the head chips 311C and 311M. In the entire area A, 4,928 nozzles (2,464 nozzles in each of the two chips) are used for printing.

The area B is an overlap area in which the head chips 311C, 311M, 312C, and 312M are arranged in the main scanning direction. The area B corresponds to 64 ejection ports (in parts of the two nozzle arrays each of which includes 32 ejection ports arranged therein) formed in each of the head chips 311C, 311M, 312C, and 312M. Thus, in the entire area B, 256 nozzles (64 nozzles in each of the four chips) are used for printing.

The area C is a non-overlap area in which only 312C and 312M are arranged in the main scanning direction. The area C corresponds to 2,464 ejection ports (in parts of the two nozzle arrays each of which includes 1,232 ejection ports) formed in each of the head chips 312C and 312M. Thus, in the entire area C, 4,928 nozzles (2,464 nozzles in each of the two chips) are used for printing.

The areas A, B, and C in the junction head 31 are used for printing. In the junction head 31 as a whole, a total of 10,112 ejection ports are arranged in four or eight columns each including 2,496 ejection ports arranged at a density of 1,200 dpi in the main scanning direction.

The areas A, B, and C in the junction head 32 are similarly arranged. That is, in the printing apparatus as a whole, a total of 20,224 ejection ports are arranged in eight or 16 columns each including 2,496 ejection ports arranged at a density of 1,200 dpi in the main scanning direction. Ink in four colors, cyan, magenta, yellow, and black is ejected through the ejection ports to print a color image.

FIG. 5 is a block diagram showing the configuration of a control system (control unit) mounted in the printing apparatus main body 1 of the ink jet printing apparatus according to the present embodiment. In FIG. 5, reference numeral 200 denotes a main control section. The main control section 200 includes a CPU 201 configured to perform process operations such as calculations, control, determinations, and settings, a ROM 202 configured to store control programs and the like to be executed by the CPU 201, and a RAM 203 configured to be able to temporarily store data. The RAM 203 is used as a buffer in which print data of two values (data “1” and “0”) indicating whether or not ink is ejected is stored and as, for example, a work area for processing executed by the CPU 201. Moreover, the main control section 200 includes an I/O port 204 to which external equipment is connected.

A carriage motor (CR motor) 211 and a conveyance motor (LF motor) 212 in the above-described conveyance unit are connected to the I/O port 204. Furthermore, the I/O port 204 connects to driving circuits 205, 206, 207, 208, and 209 for the junction heads 31 and 32, recovery processing devices 71, 72, and 73, the carriage elevating and lowering mechanism 10, and the like. Moreover, the I/O port 204 connects to a print medium sensor 11 configured to detect a print medium, a head temperature sensor 214 configured to detect the temperature of the print head, an encoder sensor 215 fixed to the carriage 2, and other sensors. Furthermore, the main control section 200 is connected to a host computer 217 via an interface circuit 216.

A printing operation performed by the ink jet printing apparatus configured as described above will be described below.

First, the printing operation will be described in brief. When the ink jet printing apparatus receives print data from the host computer 217 via an interface, the print data is expanded into a buffer in the RAM 203. When a printing operation is specified, the carriage 2 moves the junction heads 31 and 32 mounted thereon, forward (X1 direction) and backward (X2 direction) along the guide shaft 4 via the endless belt 5 moved by the carriage motor 211. At the same time, the junction heads 31 and 32 eject ink through the nozzles to form an image spanning to the arrangement width (length in the Y direction) of the nozzles. Then, the print medium is conveyed in the sub-scanning direction by a given amount. This operation is repeated a number of times to form an image in a predetermined print area on the print medium.

Now, the control of printing of the overlap portion of the junction head according to the present embodiment will be described in detail.

In the present embodiment, 2-pass printing is carried out in which the junction head performs two main scans, that is, a forward main scan and a backward main scan, on a unit area to complete an image to be printed in the unit area. Furthermore, to reduce a printing duration, the present embodiment adopts what is called bidirectional printing scheme in which the print medium is printed during both the forward and backward scans (scans in the X1 and X2 directions, respectively).

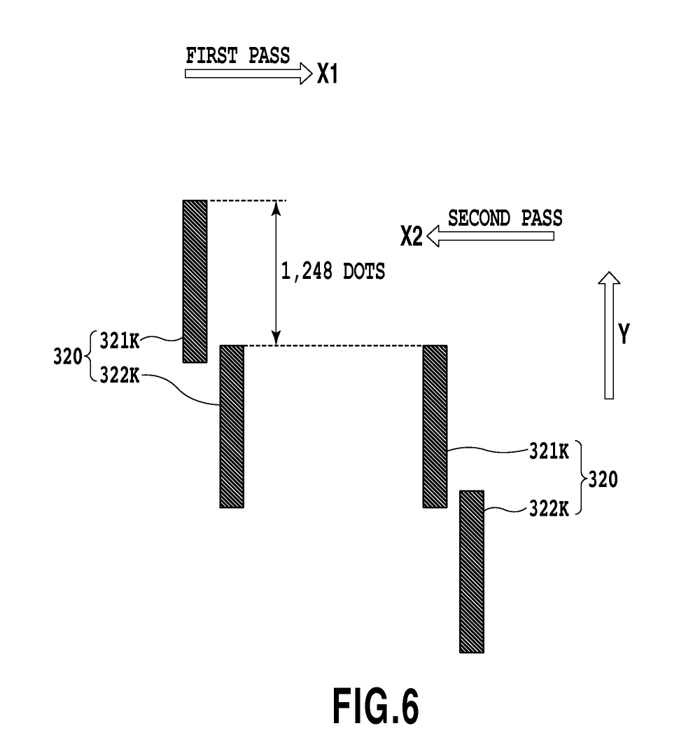

First, the basic operation of the 2-pass printing will be described with reference to the diagram in FIG. 6. In the description below, it is assumed that a black image is printed using a junction head 320 in which two head chips 321K and 322K from which black ink is ejected overlap partly in the main scanning direction. Furthermore, in the junction head, 2,496 nozzles are arranged in the sub-scanning direction at a density of 1,200 dpi.

In the 2-pass printing, the head chips 321K and 322K are supplied with thinned-out image data determined by multi-pass mask control described below. In the first pass of the printing operation, the print heads perform a forward scan (X1 direction). During the scan, dots are formed by ink droplets ejected through the ejection ports in each of the head chips. An image printed during the first pass is formed based on data obtained by decimating, under multi-pass mask control described below, binary print data corresponding to an image to be completed by two passes (main scan). That is, during the first pass of the printing operation, an image is formed which is obtained by decimating predetermined dots from the dots forming the image to be completed. In the description below, the binary data thinned-out under the multi-pass mask control is called thinned-out image data.

During the first pass, when the printing operation based on the thinned-out image data is finished, the print medium is conveyed in the sub-scanning direction (Y direction) by a distance corresponding to 1,248 dots at a density of 1,200 dpi. This conveyance distance corresponds to the width of the head chip 320 in the sub-scanning direction (a length corresponding to 2,496 dots in the Y direction). Subsequently, the junction head 320 is scanned in a direction (backward direction (X2 direction)) opposite to the main scanning direction in the first pass to perform a printing operation based on the print data used to form the image to be completed and from which the print data used for the first printing pass is removed (based on the thinned-out image data). Here, when the second pass of the printing operation is finished, the print medium is conveyed in the sub-scanning direction by a distance corresponding to 1,248 dots (2,496 dots/2) at a density of 1,200 dpi.

As described above, in the 2-pass printing, the 2,496 ejection ports arranged in the print heads 321K and 322K are divided into two ejection port groups. First, the first printing pass is performed using the lower-half ejection port group including the 1st to 1,248th ejection ports in the sequence of the nozzle arrangement. Then, the second printing pass is performed using the upper-half ejection port group including the 1,249th to 2,496th ejection ports. Thus, an image with a width corresponding to 1,248 dots is completed.

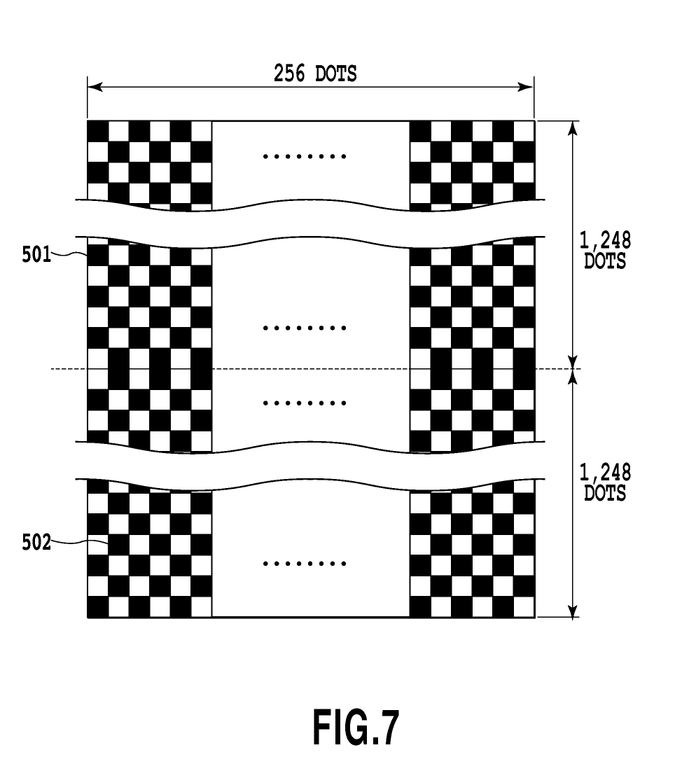

FIG. 7 is a diagram schematically showing, in association with pixels, a data thinning function based on a multi-pass mask (first thinning unit) for two passes used for a printing operation shown in FIG. 6. The multi-pass mask shown in FIG. 7 includes two masks 501 and 502 configured to distribute the print data for the image to be printed into a scan for the first pass of the 2-pass printing and a scan for the second pass. The masks 501 and 502 are set such that pixels for which the data is thinned-out have a complementary relationship with pixels for which the data is not thinned-out. In FIG. 7, black portions show the pixels for which the data is thinned-out, whereas white portions show the pixels for which the data is not thinned-out. With the multi-pass mask, a print data thinning process is carried out by performing a logical operation between input binary print data and preset binary data (logical AND process). Thus, the black pixels in FIG. 7 are specified such that a logical AND is performed on the print data and the data “1”. The white pixels are specified such that a logical AND is performed on the print data and the data “0”.

The multi-pass mask used for the 2-pass printing includes the above-described two masks. The mask 501 is a multi-pass mask used for the scanning of the head chip 321K in FIG. 6. The mask 502 is a multi-pass mask used for the scanning of the head chip 322K in FIG. 6. The size of the masks is 256 dots in the main scanning direction and 2,496 dots in the sub-scanning direction. In the main scanning direction, the masks each of 256 dots in size are repeatedly used to allow the entire main scanning width to be printed.

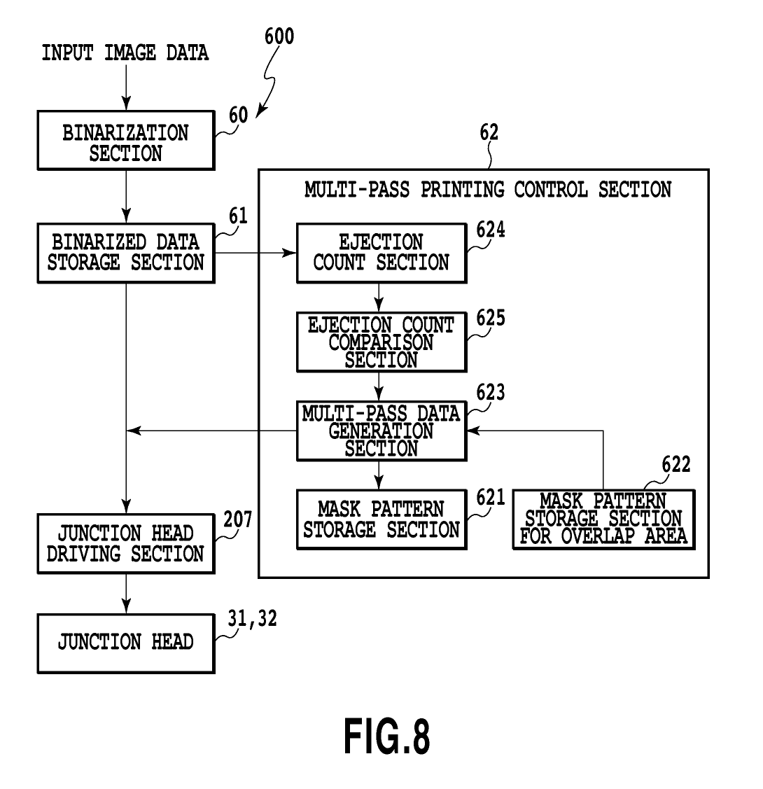

FIG. 8 is a block diagram schematically showing the configuration of a print control section 600 configured to control a multi-pass printing operation performed using the junction heads 31 and 32 shown in FIGS. 2 and 4. The print control section 600 in the present embodiment includes a binarization section 60, a binarized data storage section 61, a multi-pass print control section 62, and a junction head driving section 207. The binarization section 60 converts externally input multi-valued gradation image data in an RGB format into binarized image data in a CMYK format. The image data binarized by the binarization section 60 is output to the binarized data storage section 61 for storage. Furthermore, the junction head driving section 207 controls the operation of ejecting ink from the junction heads 31 and 32, based on print data output by the multi-pass print control section 62.

The multi-pass print control section 62 includes mask pattern storage section 621, a mask pattern storage section 622 for the overlap area, a multi-pass data generation section 623, an ejection count section 624, and an ejection count comparison section 625.

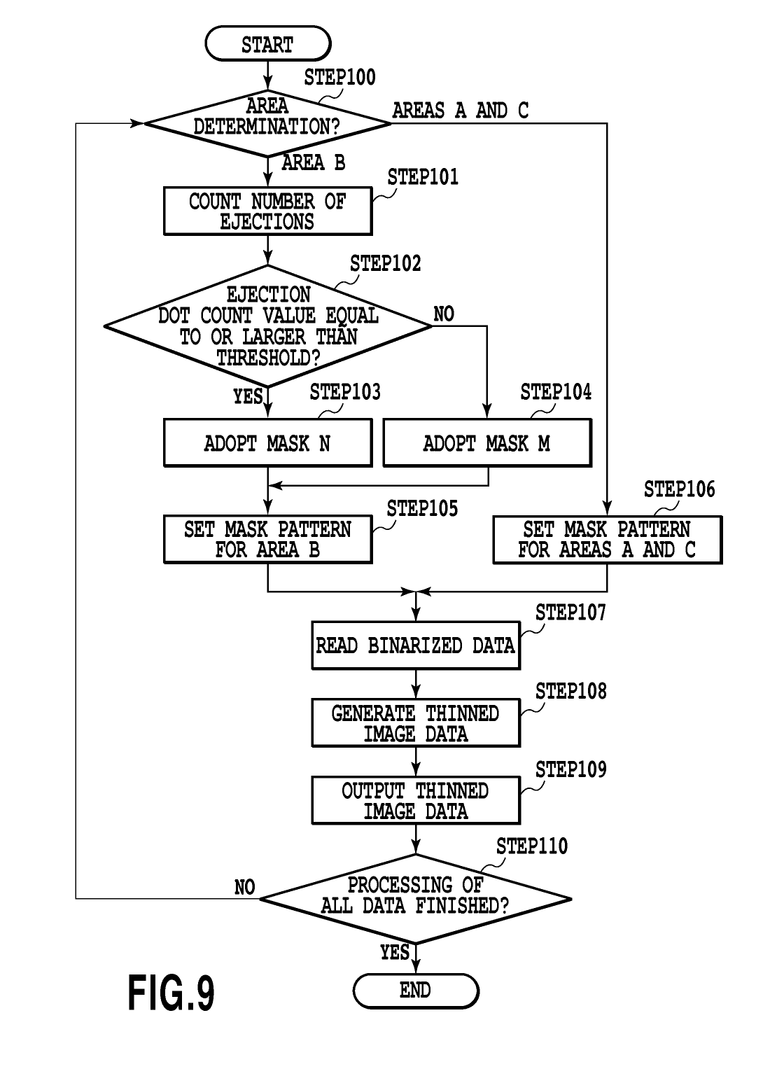

The ejection count section 624 counts the number of ink ejection operations (hereinafter referred to as the ejection count) performed in the overlap area B while the junction head 31 shown in FIG. 4 is carrying out one main scan. Ink ejection operations are counted based on the binarized data read from the binarized data storage section 61. In accordance with the flowchart shown in FIG. 9 described below, the ejection count comparison section 625 compares the ejection count obtained by the ejection count section 624 with a preset threshold for the ejection count. The ejection count comparison section 625 outputs data indicating whether or not the ejection count is equal to or larger than the threshold.

With reference to the result from the ejection count comparison section 625, the multi-pass data generation section 623 reads an overlap area mask (second thinning unit) suitable for the overlap area B in the junction head 31, from the mask pattern storage section 622 for the overlap area. At the same time, the multi-pass data generation section 623 reads a mask pattern corresponding to a set pass count as shown in FIG. 7, from the mask pattern storage section (first mask pattern storage section) 621. Then, the multi-pass data generation section 623 performs a logical operation between the read patterns to set a mask pattern corresponding to the dot count and the set pass count as well as to the overlap area B. Moreover, the multi-pass data generation section 623 performs a logical AND on the mask pattern set for the overlap area B and the binarized print data stored in the binarized data storage section 61. Thus, the final thinned-out print data is generated which is used to eject ink during main scans.

Further, the print data used to print the areas A and C shown in FIG. 4 is generated as follows. First, the multi-pass data generation section 623 reads a mask pattern corresponding to a set pass count as shown in FIG. 7, from the mask pattern storage section 621. Then, the multi-pass data generation section 623 performs a logical AND on the read mask pattern and the binarized print data stored in the binarized data storage section 61. Thus, thinned-out image data is generated which is used for printing during main scans.

The multi-pass print control section 62 includes the CPU 201, the ROM 202, and the RAM 203. The mask pattern storage section 621 and the overlap area mask pattern storage section 622 are stored in the ROM 203. Furthermore, the functions of the multi-pass data generation section 623, the ejection count section 624, and the dot count comparison section 625 are implemented by processing executed by the CPU 201 based on relevant programs stored in the ROM 202.

The junction head driving section 207 is connected to a power source (not shown in the drawings) to supply power used to eject ink from the junction heads 31 and 32 to the ejection energy generation elements provided in the nozzles in the junction heads 31 and 32. Specifically, the junction head driving section 207 selectively supplies power to the ejection energy generation elements in accordance with the binary print data generated by the multi-pass print control section 62. Hence, ink droplets are selectively ejected through the ejection ports. In conjunction with the ink droplet ejection operation, the junction heads 31 and 32 move in the main scanning direction (X direction), which is orthogonal to the nozzle arrangement direction, together with the carriage to print the print medium.

FIG. 9 is a flowchart showing the flow of processing executed by the multi-pass print control section 62. In step 100, the multi-pass print control section 62 determines whether the print data is to be printed by the area A or the area C in the junction head 31 shown in FIG. 4. Upon determining that the print data corresponds to an image is to be printed by the area B, the multi-pass print control section 62 allows the ejection count section 624 to count ink droplets ejected from the area B (step 101). Then, the multi-pass print control section 62 allows the ejection count comparison section 625 compares the ejection count with the predetermined threshold to determine whether or not the ejection count is equal to or larger than the ejection count (step 102).

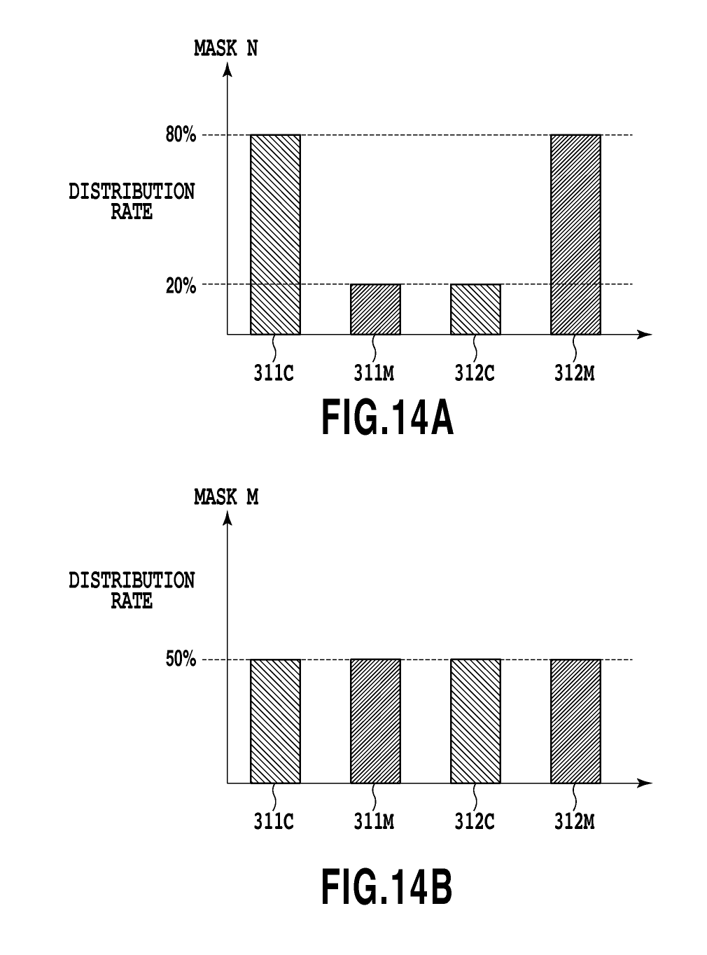

Upon determining that the ejection count value is equal to or larger than the threshold, the multi-pass print control section 62 further determines that color unevenness (hereinafter referred to as color sequence unevenness) is likely to be caused by a difference in the sequence of impact between the cyan ink and magenta ink ejected from the overlap area B. Based on the determination result, the multi-pass print control section 62 adopts a mask N shown in FIG. 14A as a mask pattern (area B mask pattern) corresponding to the overlap area B (step 103).

Furthermore, in step 102, upon determining that ejection count is smaller than the threshold, the multi-pass print control section 62 further determines that color sequence unevenness is unlikely to be caused by a difference in the sequence of landing between the cyan ink and magenta ink ejected from the overlap area B. In accordance with the determination, the multi-pass print control section 62 adopts a mask M shown in FIG. 14B as a mask pattern (area B mask pattern) corresponding to the overlap area B (step 104). The Masks N and N are mask patterns for distributing the print data for the same color to a plurality of the nozzle arrays of the overlap area (area B). In this embodiment, the mask N and M are prepared besides the mask pattern for multi-pass printing.

Then, in step 105, the multi-pass print control section 62 performs a logical AND on the area B mask pattern set in step 103 or step 104 and the multi-pass mask for two passes to set a mask pattern corresponding to the overlap area B. The mask pattern is hereinafter referred to as a synthesized mask pattern that is obtained by performing a logical AND on the area B mask pattern set in step 103 or step 104 and the multi-pass mask. The synthesized mask pattern is set in the second mask pattern storage section 622.

On the other hand, in the above-described step 100, if the input print data is determined to correspond to an image to be printed by the area A or C of the junction head, the multi-pass print control section 62 is adopted as a mask pattern corresponding to each of the areas A and C. The multi-pass print control section 62 thus adopts the multi-pass mask (step 106). The multi-pass mask is a mask pattern preset in the first mask pattern storage section 621.

Then, in step 107, the multi-pass print control section 62 reads, from the binarized data storage section 61, 2,496 dots of binarized data corresponding to the nozzles arranged in the junction heads 31 and 32 in the main scanning direction. In step 108, the multi-pass print control section 62 performs a logical AND on the mask pattern set for each area in step 105 or 106 and the binarized data read from the binarized data storage section 61 to generate thinned-out print data.

In step 109, the multi-pass print control section 62 outputs the thinned-out print data generated as described above, to the junction head driving section 207. Based on the thinned-out print data, the junction head driving section 207 drives the ejection energy generation elements in the respective nozzles in each of the junction heads 31 and 32 to print. Thereafter, in step 110, the multi-pass print control section 62 determines whether or not image processing based on all the binarized data corresponding to the image to be printed has been finished. If the image processing has not been finished, the multi-pass print control section 62 returns to step 100 to repeat the above-described processing. The binarized data read instep 107 corresponds to an area obtained by shifting the area printed by the last printing operation, by a print width corresponding to 1,248 dots (2,496 dots/2).

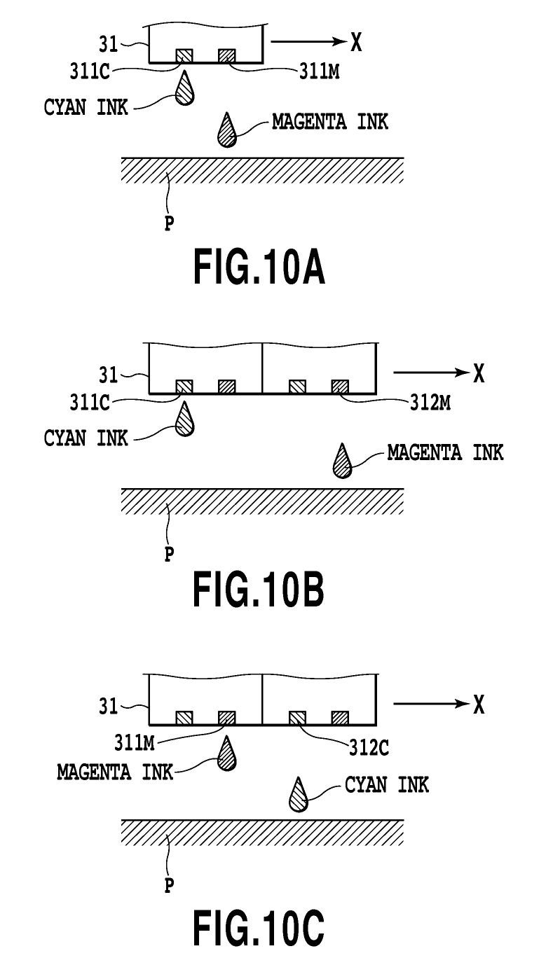

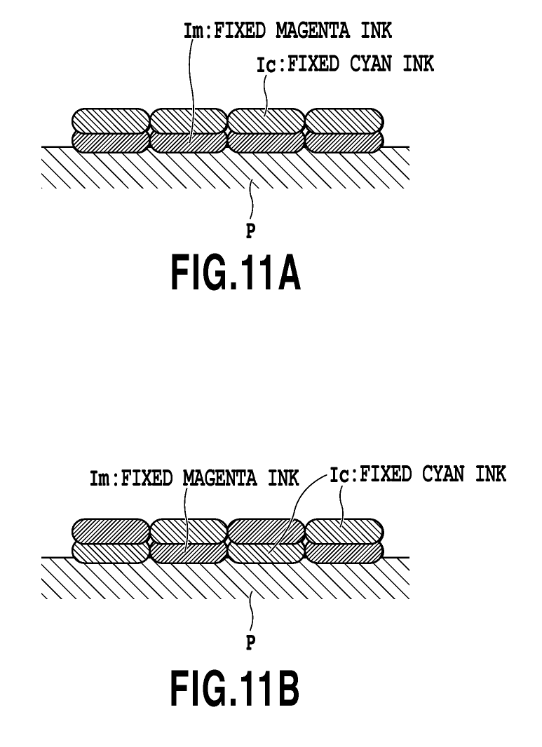

FIG. 10A to FIG. 10C, FIG. 11A, and FIG. 11B are schematic diagrams illustrating a variation in the sequence in which ink lands on the print medium if the junction heads are used for printing. In the following description, the junction head 31 is cited as a typical example. A similar phenomenon occurs in the other junction head 32, and thus the description for the junction head 32 is omitted.

In the junction head 31, in the area A including only the head chips 311C and 311M and the area C including only the head chips 312C and 312M, the sequence of ejection of ink droplets is constant as shown in FIG. 10A. In FIG. 10A, the ink is ejected in the sequence magenta and cyan. Thus, as shown in FIG. 11A, the magenta ink and then the cyan ink are overlapped on and fixed to the print medium.

Depending on the physical properties of the ink and the print medium, the ink having already impacted may be fixed to the print medium as an upper layer. However, with the physical properties of the ink and print medium used in the present embodiment, the ink is fixed to the print medium in the sequence in which the ink lands on the print medium. Thus, the magenta ink and the cyan ink are overlapped on top of each other as shown in FIG. 11A. However, whatever physical properties the ink and the print medium have, the sequence of the ink landing is correlated with the sequence of fixation. Thus, the present embodiment is effective even if the sequence of ink impact and the sequence of fixation do not have such relationships as shown in FIG. 10A and FIG. 11A. For example, similar effects are evidently obtained even if the sequence of ink impact and the sequence of fixation are reversed.

On the other hand, in the overlap area B including the head chips 311C, 311M, 312C, and 312M, the overlap mask prevents the sequence of ejection of ink droplets from being constant as shown in FIG. 10B or FIG. 10C. For example, as shown in FIG. 11B, the sequence in which the ink lands on the print medium is such that the resultant ink layer includes a mixture of a portion in which the magenta ink forms a lower layer whereas the cyan ink forms an upper layer and a portion in which the magenta ink forms an upper layer whereas the cyan ink forms a lower layer.

As described above, if the sequence of impact of the ink ejected from the overlap area B varies, when the number of ink dots per unit area is relatively large as shown in FIG. 11A and FIG. 11B, the ink is likely to be visible as color unevenness. Furthermore, the ink dots on the print medium have a high coverage. Thus, for example, striped unevenness caused by biased impact or a variation in dot size is unlikely to be visible.

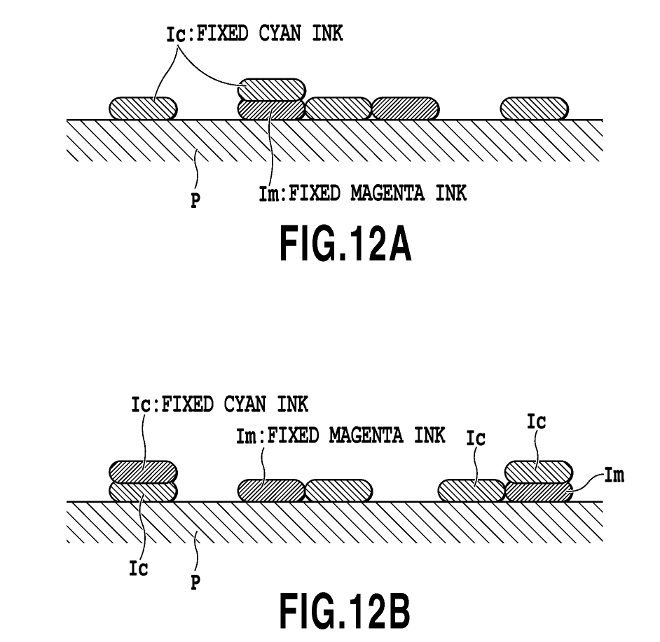

On the other hand, FIGS. 12A and 12B are schematic diagram showing that the number of ink dots per unit area is relatively small. FIG. 12A shows the sequence in which the different types of ink are overlapped on the print medium in the area A including only the two head chips 311C and 311M and the area C including only the head chips 312C and 312M. As shown in FIG. 12A, if the two types of ink are overlapped on top of each other to form a secondary color, the magenta ink and the cyan ink are fixed to the print medium so that the former forms a lower layer whereas the latter forms an upper layer. However, since the number of ink dots per unit area is small, the single color ink is often fixed without overlapping the other color ink.

FIG. 12B shows the sequence in which the different types of ink are overlapped on top of each other on the print medium P in the overlap area B including the four head chips 311C, 311M, 312C, and 312M. As shown in FIG. 12B, the resultant ink layer is a mixture of a portion in which the magenta ink Im forms a lower layer whereas the cyan ink Ic forms an upper layer and a portion in which the magenta ink forms an upper layer whereas the cyan ink forms a lower layer. However, since the number of ink dots is small, the single color ink is often fixed without overlapping the other color ink.

As described above, even if the printing of the overlap area B results in a variation in the sequence of ink landing, when the number of ink dots per unit area is relatively small, the single color ink is often fixed without overlapping the other color ink as shown in FIGS. 12A and 12B. The ink is thus likely to be visible as color unevenness. However, the ink dots on the print medium have a low ink dot coverage. Thus, for example, striped unevenness caused by biased impact or a variation in dot size is likely to be visible.

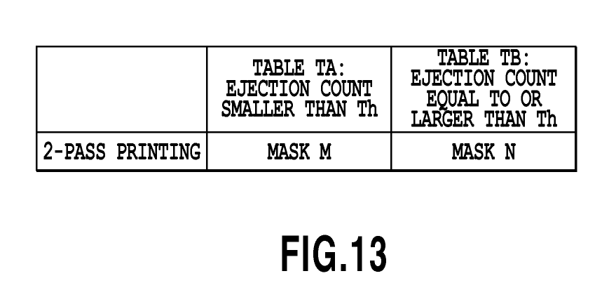

FIG. 13 is a diagram showing the relationship between the number of ink ejections in the overlap area of each of the junction heads 31 and 32 and the overlap area mask suitable for the number of ejections. In the following description, the junction head 31 is cited as atypical example. However, the description also applies to the other junction head 32, and thus duplicate descriptions are omitted.

As shown in FIG. 13, if the number of ink ejections to be provided in the overlap area B is smaller than a predetermined threshold Th, a mask M stored in a table TA is used as the overlap area mask. If the number of ink ejections to be provided in the overlap area B is equal to or larger than the threshold Th, a mask N stored in a table TB is used as the overlap area mask. The masks M and N are pre-stored in the mask pattern storage section 622 for the overlap area. Furthermore, as described above, the number of ink ejections to be provided in the overlap area B is counted by the ejection dot count section 624 shown in FIG. 8, based on the print data. Additionally, the number of ejections of ink to be ejected to the overlap area B is compared with the threshold Th by the ejection count comparison section 625.

FIG. 14A and FIG. 14B are graphs showing a rate of a distribution to the head chips 311C, 311M, 312C, and 312M in the overlap area B. FIG. 14A shows the data distribution rates based on the mask N. FIG. 14B shows the data distribution rates based on the mask M. The masks N and M are binary data specifying “1” or “0” for each pixel. In the present embodiment, the size of each of the masks N and M corresponds to 256 pixels in the main scanning direction and 32 pixels in the sub-scanning direction. If the logical values set for the pixels in the mask are all “1”, that is, the logical values set for 8,192 pixels are all “1”, the rate for the mask is specified to be 100%. Furthermore, the mask corresponding to the head chip 311C is in a complementary relationship with the mask corresponding to the head chip 312C. The head chip 311M and the head chip 312M are also in a complementary relationship. That is, the total rate for the masks corresponding to the head chips configured to eject the same color ink is 100%. A logical AND operation is pre-performed between a multi-pass mask and the masks N and M as described above. The resultant synthesized mask pattern is then applied to the print data. Thus, the print data to be printed during each scan of the overlap area B can be distributed among the head chips 311C, 311M, 312C, and 312M at the desired distribution rates shown in FIG. 14A and FIG. 14B.

If the count value for the ink ejections in the overlap area B is equal to or larger than the threshold Th, the ink is likely to be visible as color unevenness as described above. However, in this case, striped unevenness caused by deviation of landing of ink or a variation in dot size is unlikely to be visible. Thus, as shown in FIG. 13, if the count value of the number of ejections is equal to or larger than Th, the table TB is selected to set mask N. As shown in FIG. 14A, the mask N in the present embodiment is configured such that the distribution rate for the head chips 311C and 312M is set to 80%, whereas the rate for the head chips 311M and 312C is set to 20%, that is, the difference between the rates is set to 60%.

The use of the mask N sharply increase the rate of the portion in which the magenta ink forms a lower layer whereas the cyan ink forms an upper layer. Thus, color unevenness can be suppressed even if the number of ink dots per unit area is relatively large. Furthermore, if the mask N is used, since the number of ink dots per unit area is relatively large, striped unevenness caused by deviation of ink or a variation in dot size is unlikely to be visible.

On the other hand, if the dot count for the overlap area is smaller than the threshold Th, the color unevenness is unlikely to be visible as described above. However, striped unevenness caused by biased impact or a variation in dot size is likely to be visible. Thus, if the ejection count is smaller than the threshold Th, then a table TA such as one shown in FIG. 13 is selected to set a mask M.

In the present embodiment, as shown in FIG. 14B, the rate is set for each of the head chips 311C, 311M, 312C, and 312M is set to 50%.

Thus, striped unevenness caused by biased impact or a variation in dot size can be evenly distributed to the head chips 311C and 312C and to the head chips 311M and 312M. Hence, the visibility of stripe distribute or the like can be significantly suppressed. Furthermore, the number of ink dots per unit area is relatively small. Thus, the single color ink is often fixed on the print medium, and color unevenness is unlikely to occur.

In the present embodiment, when the number of ejections in the overlap portion is equal to or larger than the threshold, the distribution rate for the head chips 311C and 312M is set to 80%, whereas the distribution rate for the head chips 311M and 312C is set to 20%. However, the distribution rate for the head chips 311C and 311M may be set to 80%, whereas the distribution rate for the head chips 312C and 312M may be set to 20%. Alternatively, the distribution rate for the head chips 311C and 311M may be set to 20%, whereas the distribution rate for the head chips 312C and 312M may be set to 80%. In short, setting a difference in distribution rate between the nozzle arrays for the same color may make the number of portions with the same ink overlap sequence as that in the areas A and C larger than the number of portions with an overlap sequence different from that in the areas A and C.

That is, importantly, in the present embodiment, if the number of ejections in the overlap portion is equal to or larger the predetermined threshold, the print data for the same color is distributed among the plurality of nozzle arrays with a difference in distribution rate set between the nozzle arrays for the same color so that the number of pixels with the same ink overlap sequence as that in the areas A and C is larger than the number of pixels with an overlap sequence different from that in the areas A and C.

However, a variation in ejection characteristics among the print heads can be effectively reduced by setting the distribution rate for the head chips 311C and 312M to 80% while setting the distribution rate for the head chips 311M and 312C to 20% and providing each of the print heads with at least one column of head chips with a relatively high distribution rate, as described in the present embodiment.

On the other hand, if the number of ejections in the overlap portion is smaller than the threshold, color unevenness is unlikely to occur. Thus, a reduction in stripes is emphasized more than a reduction in color unevenness, and the distribution rate for the plurality of nozzle arrays for the same color is set to be smaller when the number of ejections in the overlap portion is smaller than the threshold than when the number of ejections in the overlap portion is equal to or larger than the threshold. In this case, the difference in distribution rate between the head chips 311C and 312C and the difference in distribution rate between the head chips 311M and 312M need not be zero. For example, the mask M is configured such that the distribution rate at which the is set for the head chips 311C and 312M is set to 55% whereas the distribution rate at which is set for the head chips 311M and 312C is set to 45%, that is, the difference in distribution rate is set to 10%. In contrast, the mask N is configured such that the distribution rate at which is set for the head chips 311C and 312M is set to 75% whereas the distribution rate is set for the head chips 311M and 312C is set to 25%, that is, the difference in distribution rate is set to 50%. Also in this case, the difference between the rates in the mask N is greater than that for the mask M. Furthermore, with the mask N, the number of portions with the same ink overlap sequence (the areas in which the cyan ink is overlapped on the magenta ink) as that in the areas A and C is larger than the number of portions with an ink overlap sequence different from that in the areas A and C. Thus, possible color unevenness and striped unevenness can be suppressed. In the present embodiment, the difference in distribution rate between the cyan head chips is the same as that between the magenta head chips. However, the difference in distribution rate may vary between cyan and magenta.

As is apparent from the above description, in the present embodiment, the difference in distribution rate between the plurality of nozzle arrays for the same color is set to be larger when the number of ejections in the overlap portion is equal to or larger than the threshold than when the number of ejections in the overlap portion is smaller than the threshold. Furthermore, the print data for the same color is distributed among the plurality of nozzle arrays for the same color so that the number of pixels with the same ink overlap sequence as that in the areas A and C is larger than the number of pixels with an overlap sequence different from that in the areas A and C if the number of ejections is equal to or larger than the predetermined threshold. Thereby, possible color unevenness and striped unevenness can be suppressed.

### Second Embodiment

Now, a second embodiment of the present invention will be described. The second embodiment corresponds to the configuration illustrated in the above-described embodiment and in which if the number of main scans per unit area is large, a threshold for controlling the overlap area mask is increased. The second embodiment is also configured as shown in FIG. 1 to FIG. 7.

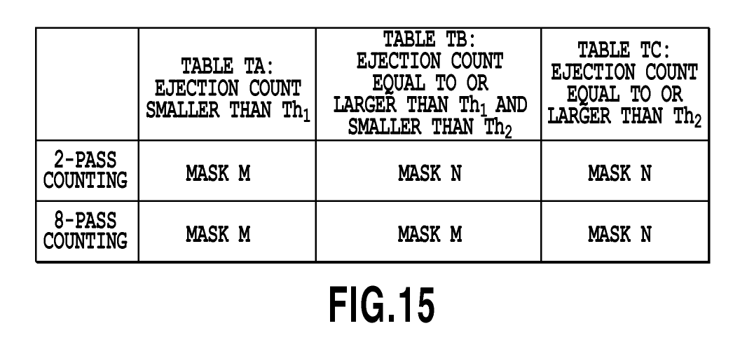

The second embodiment enables the 2-pass printing described in the first embodiment or 8-pass printing to be selectively performed; in the 8-pass printing, an image is completed by eight main scans per unit area. That is, in the second embodiment, as masks corresponding to the number of passes, mask patterns for 2-pass printing and a mask pattern for 8-pass printing are stored in the mask pattern storage section 621. Furthermore, the mask M and the mask N are stored in the overlap area B mask pattern storage section 622 as is the case with the above-described embodiment. However, as shown in FIG. 15, the number of ejections in the area B is divided into three levels for which respective three tables are specified. Here, the table TA is selected if the number of ejections in the area is smaller than Th1. The table TB is selected if the number of ejections in the area B is equal to or larger than Th1 and smaller than Th2 (Th1<Th2). Moreover, a table TC is selected if the number of ejections is equal to or larger than Th2.

According to the second embodiment, the 8-pass printing is performed by ejecting ink from the junction head based on thinned-out print data generated by the 8-pass mask and the overlap area mask pattern, with the junction head moved in the main scanning direction (for example, the forward direction). Here, when one scan is completed based on predetermined thinned-out print data, the print medium is conveyed in the sub-scanning direction by a distance corresponding to 312 dots (2,496/8) at a density of 1,200 dpi.

Subsequently, the junction head is moved in a direction (for example, the backward direction) opposite to the last main scanning direction to perform printing based on the thinned-out print data. When the printing operation based on the predetermined thinned-out print data is finished, the print medium is conveyed in the sub-scanning direction by a distance corresponding to 312 dots (2,496/8) at a density of 1,200 dpi. The main scan and the sub-scan are repeated to complete an image for the print target area. That is, the 2,496 ejection ports formed in the junction head are divided into eight groups. The image for the print target area is completed by using the ith (1+312−(i−1) to 312×i) group to print the ith pass. Thus, since the 8-pass printing is performed in the second embodiment, the sequence in which the ink lands on the print medium is more random than in the 2-pass printing both in the area A including only the head chips 311C and 311M and in the area c including only the head chips 312C and 312M. Thus, even if the overlap mask randomizes the sequence of ink impact in the area B including the head chips 311C, 311M, 312C, and 312M, color unevenness is more unlikely to occur than in the areas A and C.

Thus, when the 8-pass printing is performed, even if the ejection count value for the overlap area B is relatively large, the mask M shown in FIG. 14B is used. That is, the distribution rate which is set for each of the head chips 311C, 312M, 311M, and 312C is set to 50%. Thus, the difference in rate between the masks corresponding to the chips is set to 0%. For example, as shown in FIG. 15, even if the ejection count value is equal to or larger than the threshold Th1 and smaller than the threshold Th2, the distribution rate which is set for each head chip is set to 50%. Thus, the following are both set to 0%: the difference between the rate for the mask with respect to the head chip 311C and the rate for the mask with respect to the head chip 312C, and the difference between the rate for the mask with respect to the head chip 311M and the rate for the mask with respect to the head chip 312M.

Thus, in the second embodiment, possible color unevenness and striped unevenness can be suppressed as in the case of the first embodiment. Furthermore, the second embodiment prevents particular print heads from being subjected to an excessively large or small number of ejections. This enables an increase in the lifetime of the print head and simplification of the control.

Additionally, if the dot count for the area B is equal to or greater than the larger threshold Th2, the table TC shown in FIG. 15 is selected. Thus, as is the case with the first embodiment, possible color unevenness can be suppressed by setting a mask N such as one configured to increase the difference between the distribution rates which is set for each of the head chips 311C, 311M, 312C, and 312M.

### Third Embodiment

Now, a third embodiment will be described.

The first embodiment and the second embodiment use a junction head including head chips (nozzle arrays) for two colors arranged in parallel in one print head. However, the present embodiment uses a junction head including head chips (nozzle arrays) for three colors arranged in parallel in one print head. In the present embodiment, such a junction head is used to print an image by two-pass printing.

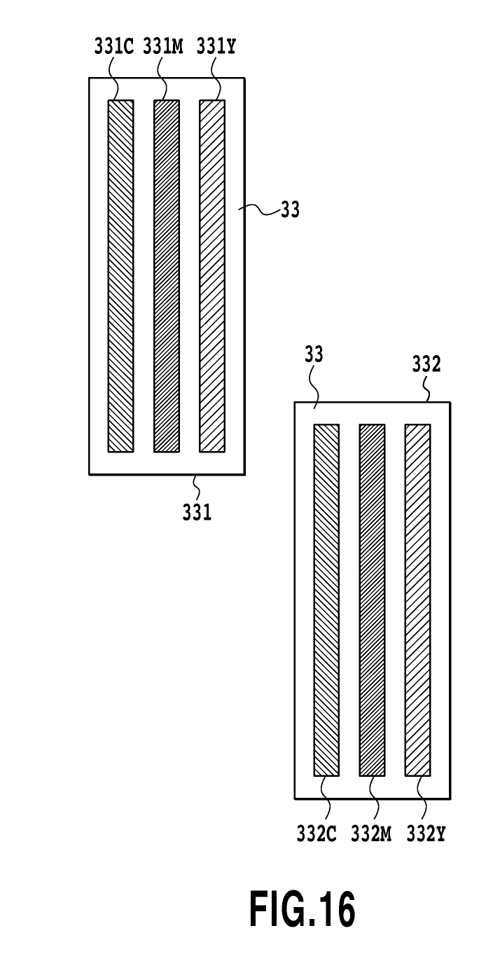

FIG. 16 shows the configuration of a junction head that can be used for the present embodiment. In FIG. 16, a junction head 33 includes two print heads 331 and 332. The print head 331 includes a head chip 331c with a plurality of nozzles arranged therein and through which cyan ink is ejected, a head chip 331M with a plurality of nozzles arranged therein and through which magenta ink is ejected, and a head chip 331Y with a plurality of nozzles arranged therein and through which yellow ink is ejected. Furthermore, the print head 332 also includes a cyan chip 332C, a magenta chip 332M, and a yellow chip 332Y. The number of nozzles in each head chip, the size of each of areas A, B, and C, and the like in the junction head 33 are similar to those in the junction head 32 according to the second embodiment.

Also in such a junction head 33, if the count value of the number of ink ejections in the overlap area is equal to or larger than a preset threshold, color evenness is likely to be visually perceived, whereas for example, striped unevenness, caused by the landing deviation of the ink droplet or a variation in dot size, is unlikely to be visually perceived, as described above.

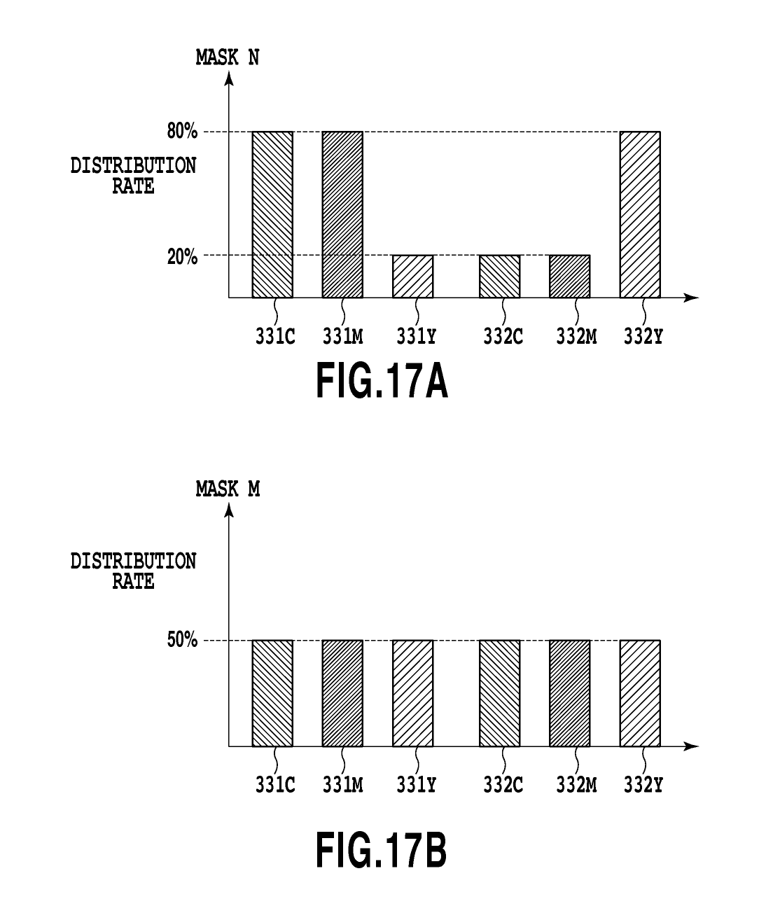

Thus, in the present embodiment, as in the case of the first embodiment, a mask N is set if the count value of the number of ejections is equal to or larger than the threshold. As shown in FIG. 17A, the mask N according to the present embodiment is configured such that the distribution rate for the head chips 331C, 331M, and 332Y is set to 80%, whereas the distribution rate for the head chips 331Y, 332C, and 332M is set to 20%; the difference in distribution rate between the nozzle arrays for the same color is set to 60%.

The use of the mask N sharply increases the rate of portions with such an ink overlap sequence on the print medium as involves a lower layer of yellow ink and an upper layer of cyan ink and magenta ink. Thus, even if the number of ink dots per unit area is relatively large, color unevenness can be suppressed. Furthermore, since the use of the mask N results in a relatively large number of ink dots per unit area, for example, striped unevenness, caused by biased impact or a variation in dot size, is unlikely to occur.

On the other hand, if the dot count in the overlap area is smaller than a preset threshold, color unevenness is unlikely to be visually perceived, whereas for example, striped unevenness, caused by the landing deviation of the ink droplet or a variation in dot size, is likely to be visually perceived, as described above. Thus, a mask M is set so as to reduce the distribution rate for the head chips 331C, 331M, 331Y, 332C, 332M, and 332Y.

In the present embodiment, as shown in FIG. 17B, the distribution rate for the head chips 331C, 331M, 331Y, 332C, 332M, and 332Y is set to 50%. That is, the mask M is configured so as to set all the differences between the head chips 331C and 332C, between the head chips 331M and 332M, and between the head chips 331Y and 332Y to 0%.

Thus, possible striped unevenness, caused by biased impact of ink droplets or a variation in dot size, can be uniformly distributed between the head chips 331C and 332C, between the head chips 331M and 332M, and between the head chips 331Y and 332Y. This allows visual perception of stripes and the like to be significantly suppressed. Furthermore, since the number of ink dots per unit area is relatively small, the surface of the print medium is covered with ink in a single color over a large area. Thus, color unevenness is unlikely to occur.

As described above, the present embodiment uses the junction head configured such that the head chips (nozzle arrays) for three colors are arranged in parallel in one print head. The mask is selected in accordance with the dot count in the overlap area to allow possible color unevenness and striped unevenness to be suppressed as is the case with the above-described first embodiment.

In the present embodiment, when a large number of passes, for example, eight passes, are used in the multi-pass operation, the mask M may be used for the overlap portion, as is the case with the second embodiment. Furthermore, when a large number of passes, for example, eight passes, are used in the multi-pass operation, if the number of ejections in the overlap portion is larger than a threshold Th2, the mask M may be used for the overlap portion.

Furthermore, the mask N may be configured such that the number of pixels with the same ink overlap sequence as that in the areas A and C is larger than the number of pixels with an overlap sequence different from that in the areas A and C. For example, the distribution rate for the head chips 311C, 332M, and 332Y may be set to 80%, whereas the distribution rate for the head chips 331Y, 331C, and 332M may be set to 20%.

Alternatively, the distribution rate for the head chips 331C, 331M, and 331Y may be set to 80%, whereas the distribution rate for the head chips 332C, 332M, and 332Y may be set to 20%. Alternatively, the distribution rate for the head chips 331C, 331M, and 331Y may be set to 20%, whereas the distribution rate for the head chips 332C, 332M, and 332Y may be set to 80%. However, as described in the first embodiment, a variation in ejection characteristics among the print heads can be effectively reduced by providing each print head with at least one column of head chips with a relatively high distribution rate. Thus, preferably, the distribution rate for the head chips 331C, 331M, and 332Y is set to 80%, whereas the distribution rate for the head chips 331Y, 332C, and 332M is set to 20% or the distribution rate for the head chips 331C, 332M, and 332Y is set to 80%, whereas the distribution rate for the head chips 331Y, 331C, and 332M is set to 20%.

As is apparent from the above description, in the present embodiment, importantly, the difference in distribution rate between the plurality of nozzle arrays for the same color is set to be larger when the number of ejections in the overlap portion is equal to or larger than the threshold than when the number of ejections is smaller than the threshold. Furthermore, the print data for the same color is distributed among the plurality of nozzle arrays for the same color so that the number of pixels with the same ink overlap sequence as that in the areas A and C is larger than the number of pixels with an overlap sequence different from that in the areas A and C if the number of ejections is equal to or larger than the predetermined threshold. Such a configuration is not limited to one print head with head chips (nozzle array) for three colors but may be one print head with head chips for at least four colors.

### Other Embodiments

In the above-described second embodiment, the 2-pass printing and the 8-pass printing can be performed. However, the present invention can be applied to an ink jet printing apparatus capable of performing multi-pass printing with main scans the number of which is other than two and eight per unit area. In the ink jet printing apparatus capable of performing multi-pass printing with a different pass count selected may be configured to avoid controllable switching of the overlap area mask if the number of main scans per unit area is greater than a predetermined given value.

That is, in 2-, 8-, and 16-pass printing, even in the area A including only the head chips 311C and 311M and the area C including only the head chips 312C and 312M, the sequence in which ink lands on the print medium is more random than in the 8-pass printing. Thus, in the area B including the head chips 311C, 311M, 312C, and 312M, color unevenness is more unlikely to occur than in the areas A and C even if the sequence of ink impact is randomized by the overlap mask. Thus, the 16-pass printing may be configured such that whatever value the number of ejections in the area B has, the distribution rate which is set for each of the mask corresponding to the head chips 311C, 312M, 311M, and 312C is set to 50%, that is, the difference between the distribution rates is set to 0%.

Moreover, in the above-described first to third embodiments, the multi-pass mask common to the overlap portion and the non-overlap portion and the mask for distribution in the overlap portion are prepared. For the non-overlap portion, the multi-pass mask is set without any change. For the overlap portion, a logical AND operation is performed between the multi-pass mask and the distribution mask to create an overlapping synthesized mask. However, a multi-pass mask for the non-overlap portion and a multi-pass mask for the overlap portion may be prepared such that the distribution rate for each head chip (nozzle array) is reflected in the multi-pass mask for the overlap portion. The present invention is not limited to multi-pass printing but is applicable to one-pass printing.

Moreover, the selectable masks are not limited to the two types M and N as described above. At least three types of masks such as ones in which the difference within the mask decreases stepwise among the masks may be prepared and selectively used. Thus, possible color unevenness and striped unevenness can be suppressed as is the case with the above-described first embodiment. Furthermore, particular print heads can be prevented from being subjected to an excessively large or small number of ejections more reliably than in the above-described second embodiment. This more reliably enables an increase in the lifetime of the print heads and simplification of the control.

Additionally, the status of fixation of the ink on the print medium is associated with the occurrence of color unevenness caused by a variation in the sequence of ink impact between the area B and the areas A and C. Thus, the number of main scans in which the controllable selection of the mask corresponding to the overlap area is avoided may be varied depending on the type of the print medium.

Furthermore, the printing apparatus in the first to third embodiments is of what is called a serial scan type. However, the present invention is also applicable to a printing apparatus of what is called a full line type. The full-line type printing apparatus uses a long junction head extending all over a print area on the print medium in the width direction. The full-line type printing apparatus allows ink to be ejected from the junction head while continuously conveying the print medium in the length direction, to continuously print an image on the print medium. That is, the present invention is widely applicable to ink jet printing apparatuses configured to print an image by setting the junction head and the print head into relative movement.

The present invention is applicable to all pieces of equipment using print media such as paper, cloths, non-woven cloths, OHP sheets, or metal. Specific examples of equipment to which the present invention is applicable include office equipment such as printers, copiers, and facsimile machines as well as industrial production equipment. Furthermore, the present invention is particularly effective on, for example, equipment configured to print large-sized print media at a high speed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-284026, filed Dec. 15, 2009, which is hereby incorporated by reference herein in its entirety.

What is claimed is:

1. An ink jet printing apparatus comprising:
printing unit comprising a plurality of print heads each with a first nozzle array through which ink in a first color is ejected and a second nozzle array through which ink in a second color is ejected, the first and second nozzle array being juxtaposed along a predetermined direction, the different print heads being arranged so as to include an overlap area in the predetermined direction;
distribution unit configured to distribute print data corresponding to the first color in the overlap area between the first nozzle arrays in respective two print heads of the plurality of print heads which correspond to the overlap area, and distributing print data corresponding to the second color in the overlap area between the second nozzle arrays in the respective two print heads; and
counting unit configured to count the number of ejections of the ink in the first color into the overlap area and the number of ejections of the ink in the second color into the overlap area based on the print data corresponding to the first color in the overlap area and the print data corresponding to the second color,
wherein:
(A) the distribution unit carries out the distribution in such a manner that a difference, between the first nozzle arrays in the respective two print heads, in a rate at which the print data corresponding to the first data is distributed to the corresponding nozzle array and a difference, between the second nozzle arrays in the respective two print heads, in a rate at which the print data corresponding to the second data is distributed to the corresponding nozzle array are larger when the number of ejections counted by the counting unit is equal to or larger than a threshold than when the number of ejections counted by the counting unit is smaller than the threshold, and
(B) the distribution unit distributes the print data corresponding to the first color and the print data corresponding to the second data between the first nozzle arrays in the respective two print heads and between the second nozzle arrays in the two print heads in such a manner that the number of pixels printed in the same printing sequence as that of the first ink and the second ink in a non-overlap area different from the overlap area is larger than the number of pixels printed in a printing sequence different from that of the first ink and the second ink in the non-overlap area.

2. The ink jet printing apparatus according to claim 1, wherein the ink jet printing apparatus is capable of carrying out printing by a plurality of relative movements between the print medium and the plurality of print heads, and the distribution unit distributes the print data corresponding to the first color and the print data corresponding to the second color for the same relative movement between the first nozzle arrays in the respective two print heads and between the second nozzle arrays in the respective two print heads.

3. The ink jet printing apparatus according to claim 2, wherein the value of the threshold increases consistently with the number of the relative movements.

4. The ink jet printing apparatus according to claim 2, wherein if the number of the relative movements is larger than a predetermined value, then regardless of the number of ejections, the difference, between the first nozzle arrays in the respective two print heads, in the rate at which the print data corresponding to the first color is distributed to the corresponding nozzle array is set to be the same as the difference, between the second nozzle arrays in the respective two print heads, in the rate at which the print data corresponding to the second color is distributed to the corresponding nozzle array.

5. The ink jet printing apparatus according to claim 1, wherein the distribution unit distributes the print data corresponding to the first color and the print data corresponding to the second color between the first nozzle arrays in the respective two print heads and between the second nozzle arrays in the respective two print heads in such a manner that the distribution rate for at least one of the nozzle arrays in each of the print heads is relatively high.

6. An ink jet printing apparatus comprising:
printing unit comprising a plurality of print heads each with a plurality of nozzle arrays juxtaposed along a predetermined direction and through which ink in different colors is ejected, the different print heads being arranged so as to include an overlap area in the predetermined direction;
distribution unit configured to distribute print data corresponding to each of the plurality of colors in the overlap area between the plurality of nozzle arrays in the two print heads corresponding to the overlap area; and
counting unit configured to count the number of ejections of the ink in the plurality of colors into the overlap area based on the print data on the plurality of colors in the overlap area,
wherein:
(A) the distribution unit carries out the distribution so as to set a difference in a rate at which the print data corresponding to each of the plurality of colors is distributed between the plurality of nozzle arrays in the respective two print heads, to be higher when the number of ejections counted by the counting unit is equal to or larger than a threshold than when the number of ejections counted by the counting unit is smaller than the threshold, and
(B) the distribution unit distributes the print data corresponding to the plurality of colors between the plurality of nozzle arrays in such a manner that the number of pixels printed in the same printing sequence as that of the ink in the plurality of colors in a non-overlap area different from the overlap area is larger than the number of pixels printed in a printing sequence different from that of the ink in the plurality of colors in the non-overlap area.

7. An ink jet printing method comprising the steps of:
carrying out printing using printing unit comprising a plurality of print heads each with a first nozzle array through which ink in a first color is ejected and a second nozzle array through which ink in a second color is ejected, the first and second nozzle array being juxtaposed along a predetermined direction, the different print heads being arranged so as to include an overlap area in the predetermined direction;
distributing print data corresponding to the first color in the overlap area between the first nozzle arrays in respective two print heads of the plurality of print heads which correspond to the overlap area, and distributing print data corresponding to the second color in the overlap area between the second nozzle arrays in the respective two print heads; and
counting the number of ejections of the ink in the first color into the overlap area and the number of ejections of the ink in the second color into the overlap area based on the print data corresponding to the first color in the overlap area and the print data corresponding to the second color,
wherein in the distribution,
(A) the distribution is carried out in such a manner that a difference, between the first nozzle arrays in the respective two print heads, in a rate at which the print data corresponding to the first data is distributed to the corresponding nozzle array and a difference, between the second nozzle arrays in the respective two print heads, in a rate at which the print data corresponding to the second data is distributed to the corresponding nozzle array are larger when the number of ejections counted by the counting unit is equal to or larger than a threshold than when the number of ejections counted by the counting unit is smaller than the threshold, and
(B) the print data corresponding to the first color and the print data corresponding to the second data are distributed between the first nozzle arrays in the respective two print heads and between the second nozzle arrays in the two print heads in such a manner that the number of pixels printed in the same printing sequence as that of the first ink and the second ink in a non-overlap area different from the overlap area is larger than the number of pixels printed in a printing sequence different from that of the first ink and the second ink in the non-overlap area.
